(19) United States
(12) Patent Application Publication
(10) Pub. No.: US 2006/0279139 A1
(43) Pub. Date: Dec. 14, 2006

(54) Universal power converter having integral AC converter

(76) Inventor: Marius Stefancscu, San Diego, CA (US)

Correspondence Address: JACKSON WALKER LLP, 901 MAIN STREET, SUITE 6000, DALLAS, TX, 75202-3797, US

(21) Appl. No.: 11/148,523

(22) Filed: Jun. 9, 2005

(51) Int. Cl. H02J 3/02

(52) U.S. Cl. 307/26

(57) ABSTRACT

A power converter adapted to power portable electronic devices and having an integral 220/110 VAC converter, and a 110/220 VAC converter. This built-in AC converter provides the suitable voltage to a integral regulator, which regulator provides a suitable output voltage and current adapted to power the portable electronic device. Advantageously, the present invention eliminates the need for the user to carry and utilize a separate detachable AC voltage converter when utilizing the converter from other international non-compatible power sources.

### FIELD OF THE INVENTION

The present invention relates to power converters, and more particularly to power converters adapted to operate from 110 VAC and 220 VAC line power.

### BACKGROUND OF THE INVENTION

Conventional power converters adapted to power and recharge portable electronic devices, such as notebook computers, PDA's, MP3 players, digital cameras, gaming devices, and so forth, are typically designed to operate from a single standard power source, such as 110 VAC in North America, and 220 VAC as is standard in European countries.

To allow these dedicated power converters to operate from the other non-compatible power source, separate detachable power converters are typically utilized to first convert 120 VAC to 110 VAC, or, from 110 AC to 220 VAC, for example. These separate AC voltage converters require the mobile user to carry and utilize an additional device, which is undesirable given the number of other electronic devices already carried by the mobile user. For instance, a typical mobile user may also carry different data devices, including USB cables, wireless data modems such as those operable using BlueTooth technology, and detachable memory devices.

There is desired an improved power converter adapted to operate directly from multiple line sources, such as those provided in North America and Europe, for example, and eliminate the need for utilizing a separate detachable AC power converter.

### SUMMARY OF INVENTION

The present invention achieves technical advantages as a power converter adapted to power portable electronic devices and having an integrated 220/110 VAC converter, and a 110/220 VAC converter. This built-in AC converter provides the suitable AC voltage to an integral voltage regulator, which regulator provides a suitable output voltage and current adapted to power the portable electronic device. Advantageously, the present invention eliminates the need for the user to carry and utilize a separate AC voltage converter when utilizing the converter from other international non-compatible line power sources.

### BRIEF DESCRIPTION OF THE DRAWINGS

FIG. 1 is a front view of a power converter according to a first embodiment of the present invention;

FIG. 2 is a back view of the power converter shown in FIG. 1;

FIG. 3 is a top view of the foldable AC in-wall connector with a plug adapter; and

FIG. 4 is an electrical block diagram of the power converter of FIG. 1 and FIG. 2 illustrating the integral AC voltage converter.

### DETAILED DESCRIPTION OF THE PRESENT INVENTION

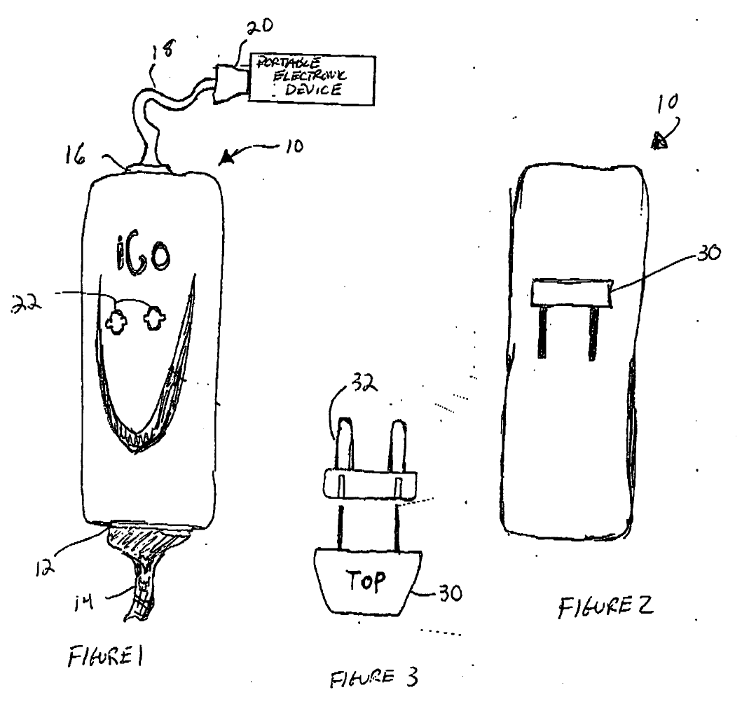

Referring now to FIG. 1 there is shown generally at 10 a power converter according to the present invention. Converter 10 is seen to include a connector 12 adapted to receive an AC power source, such as via a cord 14, connectable to a AC power source such as a 110 VAC 60 Hz line power source standard in North America, a 220 VAC 50 Hz line power source standard in European countries, or other standard AC power source provided in other countries. Converter 10 is further seen to include an output connector 16, an output power cord 18, and a detachable programming tip 20, such as provided by Mobility Electronics, Inc of Scottsdale Ariz. marketed under the iTip™ technology.

Power converter 10 also includes an AC output connector 22 adapted to provide an AC output power source, which connector 22 may be mechanically configured to receive a plug based on 110 VAC or 120 VAC standard power sources.

Referring to FIG. 2 there is shown a back view of converter 10 seen to include an optional foldable AC in-wall plug 30 adapted to couple to a standard AC line source. This foldable AC in-wall socket may be integrated into converter 10 to eliminate the need for connector 12 and power cord 14. This plug may also be provided on the end or side of the converter housing.

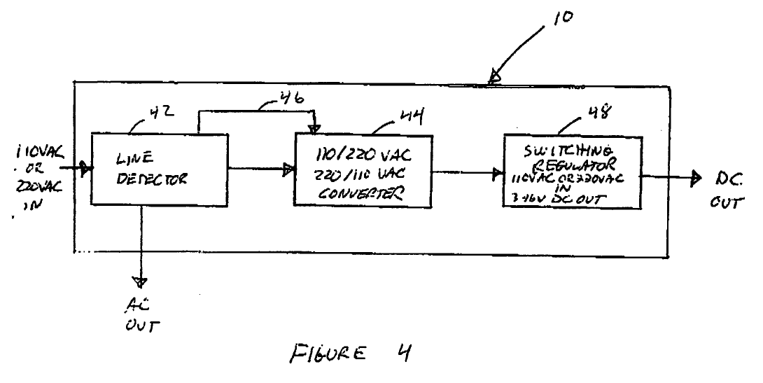

Referring to FIG. 3 there is shown a top view of the foldable AC plug 30 seen to include an AC mechanical adapter 32, shown as a European type adapter, allowing plug 30 based on the 110 VAC North American standard to be mechanically and electrically connected to a European 220 VAC power source.

In an alternative design, plug 30 may be mechanically configured to connect to a European standard socket, and the adapter 32 may be configured to receive the prongs of such a European type plug and couple to a standard North American standard socket.

Referring now to FIG. 4, there is shown an electrical block diagram of converter 10 seen to include a 220 VAC/110 VAC line detector adapted to receive and detect AC power from the AC line source, and providing AC power to an AC output socket 44 providing AC output power based on the same standard as the AC line source. Further shown is an integral AC converter 44 responsive to the line detector 42 and adapted to receive the AC power from detector 42. AC converter 44 is adapted to selectively convert the provided AC voltage based on a first standard to an AC voltage based on a different second standard. As shown, converter 44 is adapted to selectively convert standard 110 VAC to 220 VAC, and conversely, from 220 VAC to 110 VAC. Converter 44 selectively converts the input voltage as a function of a control signal provided by detector 42 on line 46, indicative of the sensed input voltage, so as to responsively convert the AC input voltage when detector 42 determines the provided AC power is based on a standard other than which converter 10 is designed for normal operation. Converter 44 will either pass on the unconverted input AC power to a switching regulator 48 if detector 42 detects the input AC power is already compliant with regulator 48, or will convert the AC power if detector 42 detects the input AC power is not compliant with the regulator 48 utilized in the power converter 10. Switching regulator 48 may also provide a selectable DC voltage and current output, such as based on the Mobility Electronics, Inc. iTip technology, or other available programming technologies, including selection switches and rotary dials with potentiometers which may be integral to converter 10.

Advantageously, AC detector 42 and AC converter 44 add only a nominal cost to converter 10, and eliminate the need for the user to carry and utilize a separate AC power converter when traveling in countries having AC power sources based on, standards non-compliant with the design of the regulator 48 provided in the users converter 10. Standard 110 VAC to 220 VAC and 220 VAC to 110 VAC converters may be integrated into converter 10, such as those utilized in the separate detachable converters. Cost savings are realized since detector 42 and converter 44 may be integrated on to the printed circuit board including regulator 48, and a separate housing and tooling is not required. Converter 44 may further provide conversion of the power source frequency between 50 Hz and 60 Hz if desired. Switching regulator 48 may be programmed to provide a suitable output voltage between 3 and 16 volts DC, at a suitable current so as to be adapted to power a portable electronic device, such as a notebook computer, MP3 player, PDA, digital camera, gaming device, and so forth.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

1. A power converter, comprising;
a housing having an input and a first output;
an AC converter disposed in the housing adapted to convert an input AC voltage based on a first standard provided to the input at a first level to a second AC voltage based on a second standard at a second level; and
a voltage regulator disposed in the housing adapted to convert the second AC voltage to a selectable DC voltage provided to the first output, the selectable DC voltage being adapted to power a portable electronic device.

2. The power converter as specified in claim 1, wherein the AC converter is adapted to convert 220 VAC said first level to 110 VAC said second AC level.

3. The power converter as specified in claim 1, wherein the AC converter is adapted to convert 110 VAC said first level to 220 VAC said second level.

4. The power converter as specified in claim 2, wherein the voltage regulator provides the selectable DC voltage being in the range of 3-16 volts DC.

5. The power converter as specified in claim 3, wherein the voltage regulator provides the selectable DC voltage being in the range of 3-16 volts DC.

6. The power converter as specified in claim 4 further including an AC line detector adapted to detect and generate a control signal as a function of the input AC voltage level.

7. The power converter as specified in claim 5 further including an AC line detector adapted to detect and generate a control signal as a function of the input AC voltage level.

8. The power converter as specified in claim 6 wherein the AC converter selectively establishes the second AC voltage level as a function of the control signal.

9. The power converter as specified in claim 7 wherein the AC converter selectively establishes the second AC voltage level as a function of the control signal.

10. The power converter as specified in claim 1 wherein the power converter provides an AC output voltage.

11. The power converter as specified in claim 10 wherein the AC output voltage is at the same voltage as the input AC voltage.
